(19) United States
(12) Patent Application Publication
(10) Pub. No.: US 2023/0189083 A1
(43) Pub. Date: Jun. 15, 2023

(54) Information Transmission Method and Apparatus, Terminal and Network Device

(71) Applicant: VIVO MOBILE COMMUNICATION CO., LTD., Dongguan (CN)

(72) Inventors: Tingting Zhong, Dongguan (CN); Yumin Wu, Dongguan (CN); Jiamin Liu, Dongguan (CN); Zhenhua Xie, Dongguan (CN)

(21) Appl. No.: 18/106,204

(22) Filed: Feb. 6, 2023

Related U.S. Application Data
(63) Continuation of application No. PCT/CN2021/110909, filed on Aug. 5, 2021.

(30) Foreign Application Priority Data
Aug. 6, 2020 (CN) 202010784968.3

(51) Int. Cl. H04W 36/00; H04W 36/08

(52) U.S. Cl. CPC H04W 36/0007; H04W 36/08; H04W 36/0061

(57) ABSTRACT

An information transmission method includes obtaining assistance information related to a multicast broadcast service; and determining a priority of a cell reselection frequency based on the assistance information.

### CROSS-REFERENCE TO RELATED APPLICATIONS

This application is a Bypass Continuation Application of PCT/CN2021/110909 filed on Aug. 5, 2021, and claims priority to Chinese Patent Application No. 202010784968.3 filed Aug. 6, 2020, the disclosures of which are hereby incorporated by reference in their entireties.

### BACKGROUND OF THE INVENTION

### Field of the Invention

The present disclosure relates to the field of communication technologies, and in particular, to an information transmission method and apparatus, a terminal, and a network device.

### Description of Related Art

A long term evolution (LTE) multimedia broadcast multicast service (MBMS) delivers a multicast transmission at a radio access network (RAN) side, while at a RAN side with a new radio (NR) multicast broadcast service (MBS), both multicast services, namely, point-to-multipoint (PTM) communication and point-to-point (PTP) communication can be supported. In a case in which user equipment (UE) can perform reception via single-cell PTM, and the UE is receiving or is interested in receiving an MBMS, the UE can receive the MBMS only when staying in a frequency providing the MBMS. However, when UE that is not in a radio resource control (RRC) connected mode performs cell reselection, it is difficult to receive an MBS as soon as possible after a corresponding cell is reselected. Consequently, the continuity of an MBS is difficult to be guaranteed.

### SUMMARY OF THE INVENTION

According to a first aspect, an information transmission method is provided. The method is performed by a terminal and includes:

obtaining assistance information related to a multicast broadcast service; and

determining a priority of a cell reselection frequency based on the assistance information.

According to a second aspect, an information transmission apparatus is provided. The apparatus is applied to a terminal and includes:

a first obtaining module, configured to obtain assistance information related to a multicast broadcast service; and

a priority level determining module, configured to determine a priority of a cell reselection frequency based on the assistance information.

According to a third aspect, an information transmission method is provided. The method is performed by a network device and includes:

sending assistance information related to a multicast broadcast service.

According to a fourth aspect, an information transmission apparatus is provided. The apparatus is applied to a network device and includes:

a first sending module, configured to send assistance information related to a multicast broadcast service.

According to a fifth aspect, a terminal is provided. The terminal includes a processor, a memory, and a program or an instruction stored in the memory and executable by the processor, where the program or instruction, when executed by the processor, implements steps of the method according to the first aspect.

According to a sixth aspect, a network device is provided. The network device includes a processor, a memory, and a program or an instruction stored in the memory and executable by the processor, where the program or instruction, when executed by the processor, implements steps of the method according to the third aspect.

According to a seventh aspect, a non-transitory readable storage medium is provided. The non-transitory readable storage medium stores a program or an instruction, where the program or instruction, when executed by a processor, implements steps of the method according to the first aspect or implements steps of the method according to the third aspect.

According to an eighth aspect, a chip is provided. The chip includes a processor and a communication interface, where the communication interface is coupled to the processor, and the processor is configured to execute a program or an instruction of a network device, to implement the method according to the first aspect or to implement the method according to the third aspect.

### BRIEF DESCRIPTION OF THE DRAWINGS

FIG. 1 is a structural diagram of a network system to which an embodiment of this disclosure may be applied;

FIG. 2 is a first schematic flowchart of an information transmission method according to an embodiment of this disclosure;

FIG. 3 is a second schematic flowchart of an information transmission method according to an embodiment of this disclosure;

FIG. 4 is a first schematic diagram of a module of an information transmission apparatus according to an embodiment of this disclosure;

FIG. 5 is a structural block diagram of a communication device according to an embodiment of this disclosure;

FIG. 6 is a structural block diagram of a terminal according to an embodiment of this disclosure; and

FIG. 7 is a second schematic diagram of a module of an information transmission apparatus according to an embodiment of this disclosure; and

FIG. 8 is a structural block diagram of a network device according to an embodiment of this disclosure.

### DESCRIPTION OF THE INVENTION

The following clearly describes the technical solutions in the embodiments of this disclosure with reference to the accompanying drawings in the embodiments of this disclosure. Apparently, the described embodiments are some but not all of the embodiments of this disclosure. All other embodiments obtained by a person of ordinary skill in the art based on the embodiments of this disclosure shall fall within the protection scope of this disclosure.

The terms “first”, “second”, and the like in the description and the claims of this disclosure are used to distinguish between similar objects instead of describing a specific order or sequence. It should be understood that, data used in this way is interchangeable in proper circumstances, so that the embodiments of this disclosure can be implemented in an order other than the order illustrated or described herein. Objects classified by “first” and “second” are usually of a same type, and the number of objects is not limited. For example, there may be one or more first objects. In addition, in the description and the claims, “and/or” represents at least one of connected objects, and a character “/” generally represents an “or” relationship between associated objects.

It should be noted that the technology described in the embodiments of this disclosure is not limited to a long term evolution (LTE)/LTE-advanced (LTE-A) system, and may also be used in various wireless communication systems, for example, code division multiple access (CDMA), time division multiple access (TDMA), frequency division multiple access (FDMA), orthogonal frequency division multiple access (OFDMA), single-carrier frequency-division multiple access (SC-FDMA), and another system. The terms “system” and “network” in the embodiments of this disclosure may be used interchangeably. The described technologies can be applied to both the systems and the radio technologies mentioned above as well as to other systems and radio technologies. However, a new radio (NR) system is described in the following description for illustrative purposes, and the NR terminology is used in most of the following description, although these technologies can also be applied to applications other than the NR system application, such as the 6-th generation (6G) communication system.

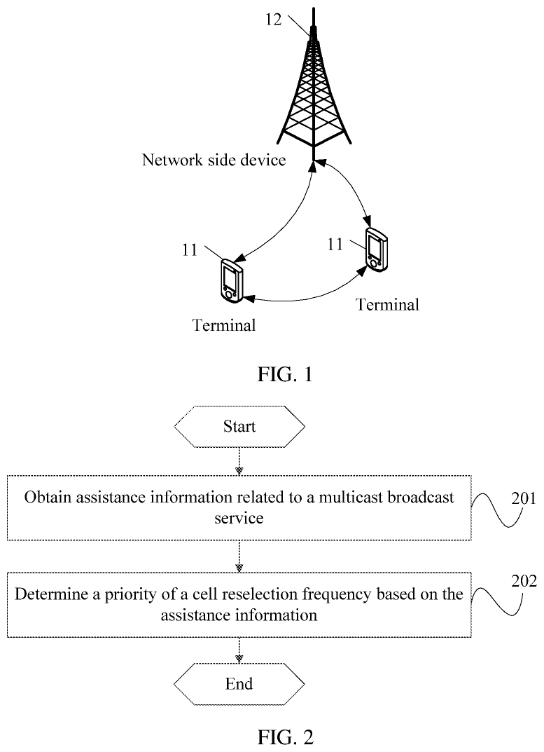

FIG. 1 is a block diagram of a wireless communication system to which embodiments of this disclosure can be applied. The wireless communication system includes a terminal 11 and a network side device 12. The terminal 11 may also be referred to as a terminal device or user equipment (UE). The terminal 11 may be a terminal side device such as a mobile phone, a tablet personal computer, a laptop computer or a notebook computer, a personal digital assistant (PDA), a palmtop computer, a netbook, an ultra-mobile personal computer (UMPC), a mobile internet device (MID), a wearable device, vehicle user equipment (VUE), or pedestrian user equipment (PUE). The wearable device includes a bracelet, a headset, glasses, and the like. It should be noted that a type of the terminal 11 is not limited in the embodiments of this disclosure. The network side device 12 may be of a base station or a core network. The base station may be referred to as a NodeB, an evolved NodeB, an access point, a base transceiver station (BTS), a radio base station, a radio transceiver, a basic service set (BSS), an extended service set (ESS), a NodeB, an evolved NodeB (eNB), a home NodeB, a home evolved NodeB, a WLAN access point, a Wi-Fi node, a transmitting receiving point (TRP), or another appropriate term in the art. As long as a same technical effect is achieved, the base station is not limited to a specified technical term. It should be noted that, in the embodiments of this disclosure, only a base station in an NR system is used as an example, but a type of the base station is not limited.

1. Description of an LTE MBMS, where the MBMS includes the following two manners of sending:

Manner 1 of MBMS sending: sending through a physical multicast channel (PMCH) in a subframe in a multimedia broadcast multicast service single frequency network. In this manner, a control information is sent by using system information (for example, SIB13) through a multicast control channel (MCCH), and data is sent through a multicast traffic channel (MTCH).

Manner 2 of MBMS sending: single-cell point-to-multipoint (SC-PTM), where

the sending uses a physical downlink shared channel (PDSCH) scheduled by a physical downlink control channel (PDCCH). In this manner, control information is sent by using system information (for example, SIB20) through a single cell multicast control channel (SC-MCCH), and data is sent through a single cell multicast traffic channel (SC-MTCH). The SC-MCCH is sent through a PDSCH scheduled by a PDCCH with a single cell radio network temporary identifier (SC-RNTI), and the SC-MTCH is sent through a PDSCH scheduled by a PDCCH with a group radio network temporary identifier (G-RNTI).

2. Introduction of SC-PTM service continuity in LTE MBMS:

User service description (USD): Before an MBMS starts, a network will notify UE about USD; and in the USD, a temporary mobile group identity (TMGI), a session start time and end time, a frequency, and a service area identifier (SAI) belonging to an MBMS service area are provided for each service at an application/service layer.

SAIs of a current frequency and a neighboring frequency are provided in SIB (system information block) 15. In a case in which one or more values of a SAI of a frequency is the same as a SAI in the USD, the UE considers that an MBMS can be provided in the frequency. It should be noted that both an MBMS cell and a non-MBMS cell can provide SIB15, provided that the cell is a primary cell (Pcell).

SIB20 provides information about obtaining the SC-MCCH; and there is SC-PTM control information in the SC-MCCH, where the information provides scheduling information of all MBMSs in a current cell and information about neighboring cell supporting each MBMS that is supported in this cell. It should be noted that only an MBMS cell can provide SIB15, and the cell is a primary cell (Pcell).

3. LTE MBMS cell reselection priority:

In a case in which the UE can perform reception via SC-PTM, and the UE is receiving or is interested in receiving an MBMS and can only stay in a frequency providing the MBMS, the UE may consider the frequency a highest priority during an MBMS session.

In conjunction with the accompanying drawings, the information transmission method provided in the embodiments of this disclosure is described in detail with some embodiments and application scenarios.

As shown in FIG. 2, an embodiment of this disclosure provides an information transmission method, performed by a terminal, and including:

Step 201: obtaining assistance information related to a multicast broadcast service.

Step 202: determining a priority of a cell reselection frequency based on the assistance information.

Herein, terminal UE that obtains the assistance information includes RRC connected UE and/or non-RRC connected UE; and the non-RRC connected UE may determine the priority of the cell reselection frequency based on the assistance information, such that UE can receive an MBS as soon as possible after reselecting a corresponding cell and achieve higher service continuity.

Optionally, the assistance information includes at least one of the following:

a description of a service feature;

information about a frequency supporting the service; or

information about a cell supporting the service.

For example, the description of the service feature may be a user service description (USD).

Optionally, the description of the service feature includes at least one of the following:

an identifier of the service, for example, a TMGI;

area information of the service;

a start time of the service, for example, a session start time;

an end time of the service, for example, a session end time; or

a frequency point of the service.

Optionally, the area information of the service includes at least one of the following:

an identifier of an area of the service, for example, a SAI (Service Area Identity);

cell information, for example, a cell list;

a radio access network-based notification area (RNA);

a tracking area (TA); or

a registration area (RA).

Optionally, the cell information includes at least one of the following:

a physical cell identifier (PCI), where, for example, the physical cell identifier may be PCI-1;

a cell global identifier (CGI), where, for example, the cell global identifier may be CGI-1;

a cell group identifier, for example, indicating a master cell group (MCG) or a secondary cell group (SCG); or

a cell type identifier, where, for example, the cell type identifier may indicate a primary cell (PCell), a primary secondary cell (PSCell), a secondary cell (SCell), or a special cell (SpCell).

Optionally, there is at least one cell indicated by the cell information.

Optionally, the frequency includes at least one of the following:

a frequency that terminal is using currently; or

a neighboring frequency.

Optionally, the information about the frequency supporting the service includes at least one of the following:

a service identifier of the frequency, namely, a service identifier corresponding to or supported by the frequency, where a method of implementing the service identifier may be a TMGI;

an area identifier of the frequency, namely, the area identifier corresponding to the frequency, where a method of implementing the area identifier may be at least one of a SAI, cell information, an RNA, a TA, and an RA; or

a service sending mode (manner) of the frequency, namely, a service sending method in the frequency, for example, PTP or PTM.

Optionally, the cell includes:

a serving cell that the terminal is located currently; and

a neighboring cell.

Optionally, the information about the cell supporting the service includes at least one of the following:

a service identifier of the cell, namely, a service identifier corresponding to or supported by the cell, where a method of implementing the service identifier may be a TMGI;

an area identifier of the cell, namely, the area identifier corresponding to the cell, where a method of implementing the area identifier may be at least one of a SAI, cell information, an RNA, a TA, or an RA; or

a service sending mode of the cell, namely, a service sending method in the cell, for example, PTP or PTM.

Optionally, the area identifier includes at least one of the following:

an area identifier of the service, for example, a SAI (Service Area Identity);

cell information, for example, a cell list;

a radio access network-based notification area (RNA);

a tracking area (TA); or

a registration area (RA).

Optionally, the service sending mode includes at least one of the following:

a point-to-multipoint (PTM) mode;

a point-to-point (PTP) mode;

a mode of waiting for a trigger;

a broadcast or multicast reception mode; or

a connected-mode reception mode.

In the PTM mode, a plurality of UEs may use a same RNTI (for example, a g-RNTI) to receive a service. In the PTP mode, the UE may use a C-RNTI (Cell-Radio Network Temporary Identifier) to receive a service. The broadcast or multicast reception mode may be a reception mode in which RRC control signaling is sent through an MCCH channel or an SC-MCCH channel. The connected-mode reception mode may be a reception mode in which RRC signaling is sent by using a connected-mode-dedicated message.

Optionally, the mode of waiting for the trigger includes one of the following:

a network device having not sent service data at a radio access network side, and a core network having sent service data to the network device, that is, for a corresponding multicast broadcast service, if a base station is temporarily in a suspended/deactivated state, when UE at a RAN side needs the service data, the base station establishes a corresponding resource to send the service data to the UE; and

a network device having not sent service data at a radio access network side, and a core network having not sent service data to the network device either, that is, for a corresponding multicast broadcast service, if a base station and a core network are temporarily in a suspended/deactivated state, when service data from a core network side arrives or UE at a RAN side needs the service data, the core network and the base station establish a corresponding resource to send the service data to the UE.

Optionally, the obtaining the assistance information related to the multicast broadcast service includes:

obtaining the assistance information related to the multicast broadcast service via at least one of the following:

a system message;

radio resource control RRC dedicated signaling;

an application-layer message; or

core network signaling.

Optionally, the method further includes:

obtaining an indication message, where the indication message is used to indicate whether the assistance information has changed.

Optionally, the indication message is a short message, a first bit or a second bit in the short message is used to indicate whether the assistance information has changed, where the first bit refers to at least one used bit in the short message, and the second bit refers to at least one bit in the short message that has not been used; or

the indication message is downlink control information scrambled with a first radio network temporary identifier RNTI, and the first RNTI refers to an RNTI different from an defined RNTI.

For example, one or more of three bits, the first to third bit in the short message that has been used, is used to indicate whether the assistance information has changed; or one or more of five bits, the fourth to eighth bit in the short message that has not been used, is used to indicate whether the assistance information has changed; or DCI (Downlink Control Information) scrambled by a new RNTI (Radio Network Temporary Identifier), for example, an X-RNTI, is used to indicate whether the assistance information has changed. The X-RNTI is applicable to all UEs in support of an MBS, all UEs interested in an MBS, or all UEs.

The short message is a transmission through a PDCCH scrambled by a paging RNTI (P-RNTI), and is in a DCI format 1_0. Bit 1 is a most significant bit.

The first bit in the short message is an indication of a system information change, and when the bit is set to 1, it is indicated that except SIB6, SIB7 and SIB8, content on a broadcast control channel (BCCH) has changed; the second bit is an indication of an earthquake and tsunami warning system (ETWS) and a commercial mobile alert system (CMAS), and when the bit is set to 1, one ETWS primary notification and/or one ETWS secondary notification and/or one CMAS notification is/are indicated; the third bit is an indication of stopping paging monitoring, and when the bit is set to 1, it is indicated that this paging occasion (PO) is a PDCCH occasion in which listening on a transmitted paging message is stopped; and the fourth to eighth bit indicate a use not in a standard release version and should be ignored if received by UE. In addition, all UEs will listen on a PDCCH addressed to a P-PNTI and determine, based on a value of each bit in the DCI, whether the system information has changed, whether to stop listening paging, and so forth.

Optionally, a terminal to which the first RNTI is applicable includes at least one of the following:

a terminal in support of a multicast broadcast service;

a terminal interested in a multicast broadcast service; or

all terminals.

That is, the first RNTI is applicable to at least the following terminals: UE in support of an MBS; UE interested in an MBS; UE that is receiving an MBS; and all UEs.

Optionally, the determining the priority of the cell reselection frequency based on the assistance information includes at least one of the following:

setting priorities of all frequencies providing a multicast broadcast service to a same priority that is a highest priority;

setting, according to a transmission manner in a multicast broadcast service, a priority of a frequency providing the multicast broadcast service; or

setting, according to a priority relationship between a frequency providing a multicast broadcast service and another frequency, a priority of the frequency providing the multicast broadcast service and/or the another priority, where the another frequency refers to a frequency that does not provide a multicast broadcast service.

Herein, the another frequency may be any frequency providing no MBS, for example, a frequency of a closed subscriber group (CSG) cell or a frequency of vehicle-to-everything (V2X).

Optionally, the setting, according to the transmission manner in the multicast broadcast service, the priority of the frequency providing the multicast broadcast service includes at least one of the following:

setting a priority of a first frequency in support of providing a multicast service to the highest priority;

setting a priority of a second frequency in support of providing a broadcast or multicast reception mode to the highest priority;

setting a priority of a third frequency in support of providing a unicast service to a lowest priority;

setting a priority of a fourth frequency in support of providing a connected-mode reception mode to the lowest priority;

setting a priority of a fifth frequency in support of providing a mode of waiting for a trigger to the lowest priority; or

setting an order of priority, where the order of priority is a priority sequence obtained after at least one of the first frequency, the second frequency, the third frequency, the fourth frequency, or the fifth frequency is arranged.

For example, an order of priority may be set to the first frequency>the second frequency>the fifth frequency, or the second frequency>the fourth frequency, or any other sequence obtained after at least one of the first frequency, the second frequency, the third frequency, the fourth frequency, or the fifth frequency is arranged.

Optionally, the priority relationship is determined by the terminal; or the priority relationship is determined according to a predefined rule.

For example, the predefined rule may be a mapping list of a fixed order of priority, or may be a rule set based on QoS (Quality of Service) as a basis for determining, or the like.

According to the information transmission method in this embodiment of this disclosure, in the assistance information related to service continuity of an MBS sent by a network, MBS service information and a sending manner of the MBS (a frequency-based service sending manner and/or a cell-based service sending manner) are provided; based on the assistance information, when performing cell reselection, non-RRC connected UE may set a frequency priority according to the sending manner of the MBS and indicate a change of the assistance information according to a mechanism using a short message or the like. By using the foregoing solution, non-RRC connected UE can better perform cell reselection, and can receive an MBS as soon as possible after reselecting a corresponding cell and achieve higher service continuity.

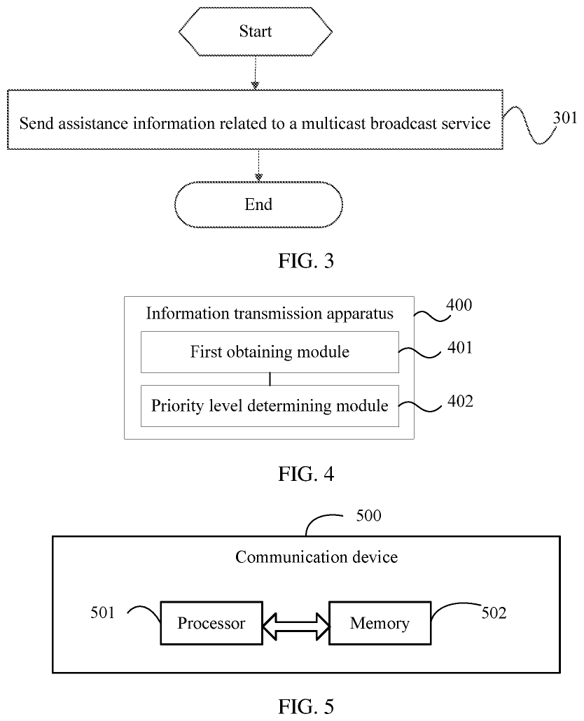

As shown in FIG. 3, an embodiment of this disclosure provides an information transmission method, performed by a network device, and including:

Step 301: sending assistance information related to a multicast broadcast service.

In this embodiment of this disclosure, by sending the assistance information to terminal UE, non-connected UE can determine a priority of a cell reselection frequency based on the assistance information, such that the UE can receive an MBS as soon as possible after reselecting a corresponding cell and achieve higher service continuity.

Optionally, the assistance information includes at least one of the following:

a description of a service feature;

information about a frequency supporting the service; or

information about a cell supporting the service.

For example, the description of the service feature may be a USD.

Optionally, the description of the service feature includes at least one of the following:

an identifier of the service, for example, a TMGI;

area information of the service;

a start time of the service, for example, a session start time;

an end time of the service, for example, a session end time; or

a frequency point of the service.

Optionally, the area information of the service includes at least one of the following:

an identifier of an area of the service, for example, a SAI (Service Area Identity);

cell information, for example, a cell list;

a radio access network-based notification area (RNA);

a tracking area (TA); or

a registration area (RA).

Optionally, the cell information includes at least one of the following:

a physical cell identifier (PCI), where, for example, the physical cell identifier may be PCI-1;

a cell global identifier (CGI), where, for example, the cell global identifier may be CGI-1;

a cell group identifier, for example, indicating a master cell group (MCG) or a secondary cell group (SCG); or

a cell type identifier, where, for example, the cell type identifier may indicate a primary cell (PCell), a primary secondary cell (PSCell), a secondary cell (SCell), or an SpCell.

Optionally, there is at least one cell indicated by the cell information.

Optionally, the frequency includes at least one of the following:

a frequency that terminal is using currently; or

a neighboring frequency.

Optionally, the information about the frequency supporting the service includes at least one of the following:

a service identifier of the frequency, namely, a service identifier corresponding to or supported by the frequency, where a method of implementing the service identifier may be a TMGI;

an area identifier of the frequency, namely, the area identifier corresponding to the frequency, where a method of implementing the area identifier is at least one of a SAI, cell information, an RNA, a TA, and an RA; or

a service sending mode of the frequency, namely, a service sending method in the frequency, for example, PTP or PTM.

Optionally, the cell includes:

a serving cell that the terminal is located currently; or

a neighboring cell.

Optionally, the information about the cell supporting the service includes at least one of the following:

a service identifier of the cell, namely, a service identifier corresponding to or supported by the cell, where a method of implementing the service identifier may be a TMGI;

an area identifier of the cell, namely, the area identifier corresponding to the cell, where a method of implementing the area identifier is at least one of a SAI, cell information, an RNA, a TA, or an RA; or

a service sending mode of the cell, namely, a service sending method in the cell, for example, PTP or PTM.

Optionally, the area identifier includes at least one of the following:

an area identifier of the service, for example, a SAI (Service Area Identity);

cell information, for example, a cell list;

a radio access network-based notification area;

a tracking area; or

a registration area.

Optionally, the service sending mode includes at least one of the following:

a point-to-multipoint (PTM) mode;

a point-to-point (PTP) mode;

a mode of waiting for a trigger;

a broadcast or multicast reception mode; or

a connected-mode reception mode.

In the PTM mode, a plurality of UEs may use a same RNTI (for example, a g-RNTI) to receive a service. In the PTP mode, UE may use a C-RNTI to receive a service. The broadcast or multicast reception mode may be a reception mode in which RRC control signaling is sent through an MCCH or an SC-MCCH. The connected-mode reception mode may be a reception mode in which RRC signaling is sent by using a connected-mode-dedicated message.

Optionally, the mode of waiting for the trigger includes one of the following:

a network device having not sent service data at a radio access network side, and a core network having sent service data to the network device, that is, for a corresponding multicast broadcast service, if a base station is temporarily in a suspended/deactivated state, when UE at a RAN side needs the service data, the base station establishes a corresponding resource to send the service data to the UE; and

a network device having not sent service data at a radio access network side, and a core network having not sent service data to the network device either, that is, for a corresponding multicast broadcast service, if a base station and a core network are temporarily in a suspended/deactivated state, when service data from a core network side arrives or UE at a RAN side needs the service data, the core network and the base station establish a corresponding resource to send the service data to the UE.

Optionally, the sending the assistance information related to the multicast broadcast service includes:

sending the assistance information related to the multicast broadcast service via at least one of the following:

a system message;

radio resource control RRC dedicated signaling;

an application-layer message; or

core network signaling.

Optionally, the method further includes:

sending an indication message, where the indication message is used to indicate whether the assistance information has changed.

Optionally, the indication message is a short message, a first bit or a second bit in the short message is used to indicate whether the assistance information has changed, where the first bit refers to at least one used bit in the short message, and the second bit refers to at least one bit in the short message that has not been used; or

the indication message is downlink control information scrambled with a first radio network temporary identifier RNTI, and the first RNTI refers to an RNTI different from an defined RNTI.

It should be noted that the indication message is described in detail in the embodiment of a terminal side, and details are not provided herein again.

Optionally, a terminal to which the first RNTI is applicable includes at least one of the following:

a terminal in support of a multicast broadcast service;

a terminal interested in a multicast broadcast service; or

all terminals.

According to the information transmission method in this embodiment of this disclosure, the assistance information related to service continuity sent by a network includes a sending manner of the MBS; based on the assistance information, non-RRC connected UE can better perform cell reselection, and can receive an MBS as soon as possible after reselecting a corresponding cell and achieve higher service continuity.

It should be noted that the information transmission method provided in this embodiment of this disclosure can be performed by an information transmission apparatus or a control module included in the information transmission apparatus and configured to perform the information transmission method. In an embodiment of this disclosure, the information transmission apparatus provided in this embodiment of this disclosure is described by using an example in which the information transmission method is performed by the information transmission apparatus.

As shown in FIG. 4, an embodiment of this disclosure further provides an information transmission apparatus 400, applied to a terminal, and including:

a first obtaining module 401, configured to obtain assistance information related to a multicast broadcast service; and

a priority level determining module 402, configured to determine a priority of a cell reselection frequency based on the assistance information.

According to the information transmission apparatus in this embodiment of this disclosure, the assistance information includes at least one of the following:

a description of a service feature;

information about a frequency supporting the service; or

information about a cell supporting the service.

According to the information transmission apparatus in this embodiment of this disclosure, the description of the service feature includes at least one of the following:

an identifier of the service;

area information of the service;

a start time of the service;

an end time of the service; or

a frequency point of the service.

According to the information transmission apparatus in this embodiment of this disclosure, the area information of the service includes at least one of the following:

an identifier of an area of the service;

cell information;

a radio access network-based notification area;

a tracking area; or

a registration area.

According to the information transmission apparatus in this embodiment of this disclosure, the cell information includes at least one of the following:

a physical cell identifier;

a cell global identifier;

a cell group identifier; or

a cell type identifier.

According to the information transmission apparatus in this embodiment of this disclosure, there is at least one cell indicated by the cell information.

According to the information transmission apparatus in this embodiment of this disclosure, the frequency includes at least one of the following:

a frequency that terminal is using currently; or

a neighboring frequency.

According to the information transmission apparatus in this embodiment of this disclosure, the information about the frequency supporting the service includes at least one of the following:

a service identifier of the frequency;

an area identifier of the frequency; or

a service sending mode of the frequency.

According to the information transmission apparatus in this embodiment of this disclosure, the cell includes:

a serving cell that the terminal is located currently; or

a neighboring cell.

According to the information transmission apparatus in this embodiment of this disclosure, the information about the cell supporting the service includes at least one of the following:

a service identifier of the cell;

an area identifier of the cell; or

a service sending mode of the cell.

According to the information transmission apparatus in this embodiment of this disclosure, the area identifier includes at least one of the following:

an area identifier of the service;

cell information;

a radio access network-based notification area;

a tracking area; or

a registration area.

According to the information transmission apparatus in this embodiment of this disclosure, the service sending mode includes at least one of the following:

a point-to-multipoint PTM mode;

a point-to-point PTP mode;

a mode of waiting for a trigger;

a broadcast or multicast reception mode; or

a connected-mode reception mode.

According to the information transmission apparatus in this embodiment of this disclosure, the mode of waiting for the trigger includes one of the following:

a network device having not sent service data at a radio access network side, and a core network having sent service data to the network device; and

a network device having not sent service data at a radio access network side, and a core network having not sent service data to the network device either.

According to the information transmission apparatus in this embodiment of this disclosure, the first obtaining module 401 is configured to obtain the assistance information related to the multicast broadcast service via at least one of the following:

a system message;

radio resource control RRC dedicated signaling;

an application-layer message; or

core network signaling.

The information transmission apparatus in this embodiment of this disclosure further includes:

a second obtaining module, configured to obtain an indication message, where the indication message is used to indicate whether the assistance information has changed.

According to the information transmission apparatus in this embodiment of this disclosure, the indication message is a short message, a first bit or a second bit in the short message is used to indicate whether the assistance information has changed, where the first bit refers to at least one used bit in the short message, and the second bit refers to at least one bit in the short message that has not been used; or

the indication message is downlink control information scrambled with a first radio network temporary identifier RNTI, and the first RNTI refers to an RNTI different from an defined RNTI.

According to the information transmission apparatus in this embodiment of this disclosure, a terminal to which the first RNTI is applicable includes at least one of the following:

a terminal in support of a multicast broadcast service;

a terminal interested in a multicast broadcast service; or

all terminals.

According to the information transmission apparatus in this embodiment of this disclosure, the priority level determining module 402 includes at least one of the following:

a first determining submodule, configured to set priorities of all frequencies providing a multicast broadcast service to a same priority that is a highest priority;

a second determining submodule, configured to set, according to a transmission manner in a multicast broadcast service, a priority of a frequency providing the multicast broadcast service; or

a third determining submodule, configured to set, according to a priority relationship between a frequency providing a multicast broadcast service and another frequency, a priority of the frequency providing the multicast broadcast service and/or the another priority, where the another frequency refers to a frequency that does not provide a multicast broadcast service.

According to the information transmission apparatus in this embodiment of this disclosure, the second determining submodule includes at least one of the following:

a first determining unit, configured to use a first frequency in support of providing a multicast service as the highest priority;

a second determining unit, configured to use a second frequency in support of providing a broadcast or multicast reception mode as the highest priority;

a third determining unit, configured to use a third frequency in support of providing a unicast service as a lowest priority;

a fourth determining unit, configured to use a fourth frequency in support of providing a connected-mode reception mode as the lowest priority;

a fifth determining unit, configured to use a fifth frequency in support of providing a mode of waiting for a trigger as the lowest priority; or

a sixth determining unit, configured to set an order of priority, where the order of priority is a priority sequence obtained after at least one of the first frequency, the second frequency, the third frequency, the fourth frequency, or the fifth frequency is arranged.

According to the information transmission apparatus in this embodiment of this disclosure, the priority relationship is determined by the terminal; or the priority relationship is determined according to a predefined rule.

According to the information transmission apparatus in this embodiment of this disclosure, the assistance information related to service continuity sent by a network includes a sending manner of the MBS; based on the assistance information, non-RRC connected UE can better perform cell reselection, and can receive an MBS as soon as possible after reselecting a corresponding cell and achieve higher service continuity.

The information transmission apparatus in this embodiment of this disclosure may be an apparatus, or may be a component, an integrated circuit, or a chip in a terminal. The apparatus may be a mobile terminal, or a non-mobile terminal. For example, the mobile device may include but is not limited to the types of the terminal 11 listed above, and the non-mobile terminal may be a server, a network attached storage (NAS), a personal computer (PC), a television (TV), an automated teller machine, or a self-service machine. This is not limited in the embodiments of this disclosure.

The information transmission apparatus in this embodiment of this disclosure may be an apparatus with an operating system. The operating system may be an Android operating system, an iOS operating system, or another possible operating system. This is not limited in the embodiments of this disclosure.

The information transmission apparatus provided in this embodiment of this disclosure can implement the processes implemented in the method embodiments of FIG. 1 and FIG. 2, with the same technical effect achieved. To avoid repetition, details are not described herein again.

Optionally, as shown in FIG. 5, an embodiment of this disclosure further provides a communication device 500, including a processor 501, a memory 502, a program or an instruction that is stored in the memory 502 and that can execute on the processor 501. For example, when the communication device 500 is a terminal, the program or the instruction is executed by the processor 501 to implement processes of the embodiment of the foregoing information transmission method performed by the terminal, with the same technical effect achieved. When the communication device 500 is a network device, the program or the instruction, when executed by the processor 501, implements processes of the embodiment of the foregoing information transmission method performed by the network side device, with the same technical effect achieved. To avoid repetition, details are not described herein again.

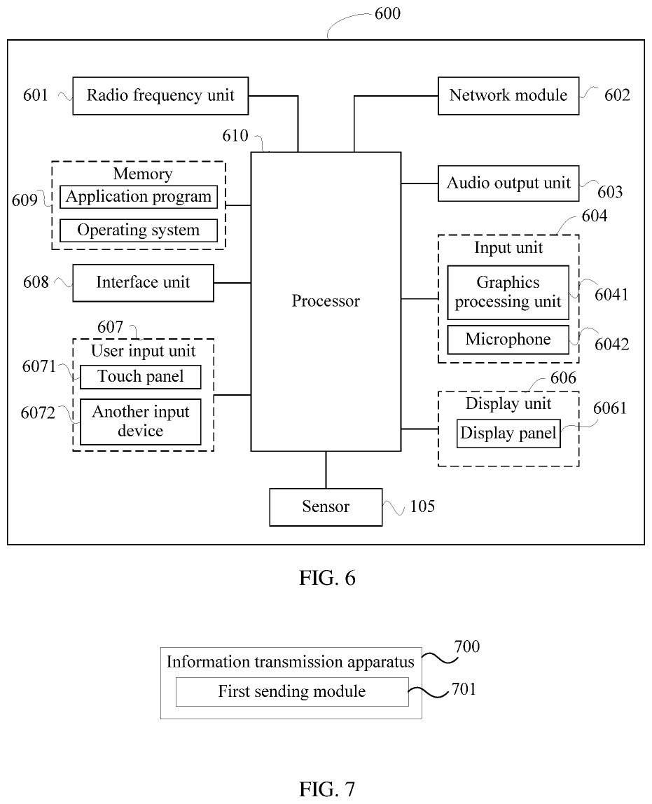

FIG. 6 is a schematic diagram of a hardware structure of a terminal according to an embodiment of this disclosure.

The terminal 600 includes but is not limited to components such as a radio frequency unit 601, a network module 602, an audio output unit 603, an input unit 604, a sensor 605, a display unit 606, a user input unit 607, an interface unit 608, a memory 609, and a processor 610.

It may be understood by a person skilled in the art that the terminal 600 may further include a power supply (such as a battery) that supplies power to each component. The power supply may be logically connected to the processor 610 by using a power management system, to implement functions such as charging, discharging, and power consumption management by using the power management system. The terminal structure shown in FIG. 6 constitutes no limitation on the terminal, and the terminal may include more or fewer components than those shown in the figure, or combine some components, or have different component arrangements. Details are not described herein.

It should be understood that, in this embodiment of this disclosure, the input unit 604 may include a graphics processing unit (GPU) 6041 and a microphone 6042. The graphics processing unit 6041 processes image data of a static picture or a video obtained by an image capture apparatus (such as a camera) in a video capture mode or an image capture mode. The display unit 606 may include a display panel 6061, and the display panel 6061 may be configured in a form of a liquid crystal display, an organic light-emitting diode, or the like. The user input unit 607 includes a touch panel 6071 and another input device 6072. The touch panel 6071 is also referred to as a touchscreen. The touch panel 6071 may include two parts: a touch detection apparatus and a touch controller. The another input device 6072 may include but is not limited to a physical keyboard, a functional button (such as a volume control button or a power on/off button), a trackball, a mouse, and a joystick. Details are not described herein.

In this embodiment of this disclosure, the radio frequency unit 601 receives downlink data from a network device and then sends the downlink data to the processor 610 for processing; and sends uplink data to the network device. Generally, the radio frequency unit 601 includes but is not limited to: an antenna, at least one amplifier, a transceiver, a coupler, a low noise amplifier, a duplexer, and the like.

The memory 609 may be configured to store a software program or an instruction and various data. The memory 609 may mainly include a program or instruction storage area and a data storage area. The program or instruction storage area may store an operating system, and an application or an instruction required by at least one function (for example, a sound playing function or an image playing function). In addition, the memory 609 may include a high-speed random access memory, and may further include a non-volatile memory. The non-volatile memory may be a read-only memory (ROM), a programmable read-only memory (PROM), an erasable programmable read-only memory (EPROM), an electrically erasable programmable read-only memory (EEPROM), or a flash memory, for example, at least one disk storage component, a flash memory component, or another non-volatile solid-state storage component.

The processor 610 may include one or more processing units. Optionally, an application processor and a modem processor may be integrated into the processor 610. The application processor mainly processes an operating system, a user interface, an application, an instruction, or the like. The modem processor mainly processes wireless communication, for example, a baseband processor. It can be understood that, alternatively, the modem processor may not be integrated into the processor 610.

The processor 610 is configured to send assistance information related to a multicast broadcast service.

Optionally, the assistance information includes at least one of the following:

a description of a service feature;

information about a frequency supporting the service; or

information about a cell supporting the service.

Optionally, the description of the service feature includes at least one of the following:

an identifier of the service;

area information of the service;

a start time of the service;

an end time of the service; or

a frequency point of the service.

Optionally, the area information of the service includes at least one of the following:

an identifier of an area of the service;

cell information;

a radio access network-based notification area;

a tracking area; or

a registration area.

Optionally, the cell information includes at least one of the following:

a physical cell identifier;

a cell global identifier;

a cell group identifier; or

a cell type identifier.

Optionally, there is at least one cell indicated by the cell information.

Optionally, the frequency includes at least one of the following:

a frequency that terminal is using currently; or

a neighboring frequency.

Optionally, the information about the frequency supporting the service includes at least one of the following:

a service identifier of the frequency;

an area identifier of the frequency; or

a service sending mode of the frequency.

Optionally, the cell includes:

a serving cell that the terminal is located currently; or

a neighboring cell.

Optionally, the information about the cell supporting the service includes at least one of the following:

a service identifier of the cell;

an area identifier of the cell; or

a service sending mode of the cell.

Optionally, the area identifier includes at least one of the following:

an area identifier of the service;

cell information;

a radio access network-based notification area;

a tracking area; or

a registration area.

Optionally, the service sending mode includes at least one of the following:

a point-to-multipoint PTM mode;

a point-to-point PTP mode;

a mode of waiting for a trigger;

a broadcast or multicast reception mode; or

a connected-mode reception mode.

Optionally, the mode of waiting for the trigger includes one of the following:

a network device having not sent service data at a radio access network side, and a core network having sent service data to the network device; and

a network device having not sent service data at a radio access network side, and a core network having not sent service data to the network device either.

Optionally, the processor 610 is further configured to send the assistance information related to the multicast broadcast service via at least one of the following:

a system message;

radio resource control RRC dedicated signaling;

an application-layer message; or

core network signaling.

Optionally, the processor 610 is further configured to send an indication message, where the indication message is used to indicate whether the assistance information has changed.

Optionally, the indication message is a short message, a first bit or a second bit in the short message is used to indicate whether the assistance information has changed, where the first bit refers to at least one used bit in the short message, and the second bit refers to at least one bit in the short message that has not been used; or

the indication message is downlink control information scrambled with a first radio network temporary identifier RNTI, and the first RNTI refers to an RNTI different from an defined RNTI.

Optionally, a terminal to which the first RNTI is applicable includes at least one of the following:

a terminal in support of a multicast broadcast service;

a terminal interested in a multicast broadcast service; or

all terminals.

According to the terminal in this embodiment of this disclosure, the assistance information related to service continuity sent by a network includes a sending manner of the MBS; based on the assistance information, non-RRC connected UE can better perform cell reselection, and can receive an MBS as soon as possible after reselecting a corresponding cell and achieve higher service continuity.

It should be noted that the information transmission method provided in this embodiment of this disclosure can be performed by an information transmission apparatus or a control module included in the information transmission apparatus and configured to perform the information transmission method. In an embodiment of this disclosure, the information transmission apparatus provided in this embodiment of this disclosure is described by using an example in which the information transmission method is performed by the information transmission apparatus.

As shown in FIG. 7, an embodiment of this disclosure further provides an information transmission apparatus 700, applied to a network device, and including:

a first sending module 701, configured to send assistance information related to a multicast broadcast service.

According to the information transmission apparatus in this embodiment of this disclosure, the assistance information includes at least one of the following:

a description of a service feature;

information about a frequency supporting the service; or

information about a cell supporting the service.

According to the information transmission apparatus in this embodiment of this disclosure, the description of the service feature includes at least one of the following:

an identifier of the service;

area information of the service;

a start time of the service;

an end time of the service; or

a frequency point of the service.

According to the information transmission apparatus in this embodiment of this disclosure, the area information of the service includes at least one of the following:

an identifier of an area of the service;

cell information;

a radio access network-based notification area;

a tracking area; or

a registration area.

According to the information transmission apparatus in this embodiment of this disclosure, the cell information includes at least one of the following:

a physical cell identifier;

a cell global identifier;

a cell group identifier; or

a cell type identifier.

According to the information transmission apparatus in this embodiment of this disclosure, there is at least one cell indicated by the cell information.

According to the information transmission apparatus in this embodiment of this disclosure, the frequency includes at least one of the following:

a frequency that terminal is using currently; or

a neighboring frequency.

According to the information transmission apparatus in this embodiment of this disclosure, the information about the frequency supporting the service includes at least one of the following:

a service identifier of the frequency;

an area identifier of the frequency; or

a service sending mode of the frequency.

According to the information transmission apparatus in this embodiment of this disclosure, the cell includes:

a serving cell that the terminal is located currently; and

a neighboring cell.

According to the information transmission apparatus in this embodiment of this disclosure, the information about the cell supporting the service includes at least one of the following:

a service identifier of the cell;

an area identifier of the cell; or

a service sending mode of the cell.

According to the information transmission apparatus in this embodiment of this disclosure, the area identifier includes at least one of the following:

an area identifier of the service;

cell information;

a radio access network-based notification area;

a tracking area; or

a registration area.

According to the information transmission apparatus in this embodiment of this disclosure, the service sending mode includes at least one of the following:

a point-to-multipoint PTM mode;

a point-to-point PTP mode;

a mode of waiting for a trigger;

a broadcast or multicast reception mode; or

a connected-mode reception mode.

According to the information transmission apparatus in this embodiment of this disclosure, the mode of waiting for the trigger includes one of the following:

a network device having not sent service data at a radio access network side, and a core network having sent service data to the network device; and

a network device having not sent service data at a radio access network side, and a core network having not sent service data to the network device either.

According to the information transmission apparatus in this embodiment of this disclosure, that the sending the assistance information related to the multicast broadcast service includes:

sending the assistance information related to the multicast broadcast service via at least one of the following:

a system message;

radio resource control RRC dedicated signaling;

an application-layer message; or

core network signaling.

The information transmission apparatus in this embodiment of this disclosure further includes:

a second sending module, configured to send an indication message, where the indication message is used to indicate whether the assistance information has changed.

According to the information transmission apparatus in this embodiment of this disclosure, the indication message is a short message, a first bit or a second bit in the short message is used to indicate whether the assistance information has changed, where the first bit refers to at least one used bit in the short message, and the second bit refers to at least one bit in the short message that has not been used; or

the indication message is downlink control information scrambled with a first radio network temporary identifier RNTI, and the first RNTI refers to an RNTI different from an defined RNTI.

According to the information transmission apparatus in this embodiment of this disclosure, a terminal to which the first RNTI is applicable includes at least one of the following:

a terminal in support of a multicast broadcast service;

a terminal interested in a multicast broadcast service; or

all terminals.

According to the information transmission apparatus in this embodiment of this disclosure, the assistance information related to service continuity sent by a network includes a sending manner of the MBS; based on the assistance information, non-RRC connected UE can better perform cell reselection, and can receive an MBS as soon as possible after reselecting a corresponding cell and achieve higher service continuity.

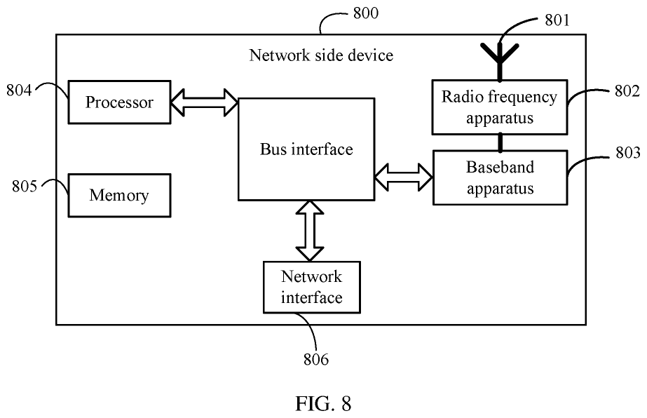

Illustratively, an embodiment of this disclosure further provides a network device. As shown in FIG. 8, a network device 800 includes an antenna 801, a radio frequency apparatus 802, and a baseband apparatus 803. The antenna 801 is connected to the radio frequency apparatus 802. In an uplink direction, the radio frequency apparatus 802 receives information by using the antenna 801, and sends the received information to the baseband apparatus 803 for processing. In a downlink direction, the baseband apparatus 803 processes information that needs to be sent, and sends processed information to the radio frequency apparatus 802. The radio frequency apparatus 802 processes the received information, and sends processed information by using the antenna 801.

The frequency band processing apparatus may be located in the baseband apparatus 803. The method performed by the network device in the foregoing embodiment may be implemented in the baseband apparatus 803. The baseband apparatus 803 includes a processor 804 and a memory 805.

The baseband apparatus 803 may include, for example, at least one baseband board, where a plurality of chips are disposed on the baseband board. As shown in FIG. 8, one chip is, for example, the processor 804, which is connected to the memory 805, so as to invoke a program in the memory 805 to perform operations of the network device shown in the foregoing method embodiment.

The baseband apparatus 803 may further include a network interface 806, configured to exchange information with the radio frequency apparatus 802, where the interface is, for example, a common public radio interface (CPRI for short).

Illustratively, the network device in this embodiment of the present invention further includes an instruction or a program that is stored in the memory 805 and that can be execute on the processor 804. The processor 804 invokes the instruction or the program in the memory 805 to perform the method performed by the modules shown in FIG. 5, with the same technical effect achieved. To avoid repetition, details are not described herein again.

An embodiment of this disclosure further provides a non-transitory readable storage medium, where the non-transitory readable storage medium stores a program or an instruction, and the program or the instruction, when executed by a processor, implements the processes of the foregoing information transmission method embodiments, with the same technical effect achieved. To avoid repetition, details are not described herein again.

The processor is a processor in the terminal in the above embodiment. The non-transitory readable storage medium includes a non-transitory computer-readable storage medium such as a read-only memory (ROM), a random access memory (RAM), a magnetic disk, an optical disc, or the like.

An embodiment of this disclosure further provides a chip. The chip includes a processor and a communication interface, the communication interface is coupled to the processor, and the processor is configured to execute a program or an instruction of a network device to implement the foregoing processes of the foregoing information transmission method embodiments, with the same technical effect achieved. To avoid repetition, details are not described herein again.

It should be understood that the chip mentioned in this embodiment of this disclosure may also be referred to as a system-level chip, a system chip, a chip system, or an on-chip system chip.

An embodiment of this disclosure further provides a computer program product. The program product is stored in a nonvolatile storage medium. The program product is executed by at least one processor to implement the processes of the foregoing information transmission method embodiments, with the same technical effect achieved. To avoid repetition, details are not described herein again.

It can be understood that the embodiments described in the present disclosure may be implemented by hardware, software, firmware, middleware, microcode, or a combination thereof. For implementation with hardware, the module, unit, submodule, subunit, and the like may be implemented in one or more application specific integrated circuits (ASIC), a digital signal processor (DSP), a digital signal processing device (DSPD), a programmable logic device (PLD), a field-programmable gate array (FPGA), a general-purpose processor, a controller, a microcontroller, a microprocessor, another electronic unit for implementing the functions of this disclosure, or a combination thereof.

It should be noted that, in this specification, the terms “include”, “comprise”, or any other variant thereof is intended to cover a non-exclusive inclusion, so that a process, a method, an article, or an apparatus that includes a list of elements not only includes those elements, but also includes other elements which are not expressly listed, or further includes elements inherent to such process, method, article, or apparatus. In the absence of more restrictions, an element defined by the statement “including a . . . ” does not preclude the presence of other identical elements in the process, method, article, or apparatus that includes the element. In addition, it should be noted that the scope of the method and the apparatus in the embodiments of this disclosure is not limited to performing functions in an illustrated or discussed sequence, and may further include performing functions in a basically simultaneous manner or in a reverse sequence according to the functions concerned. For example, the described method may be performed in an order different from that described, and the steps may be added, omitted, or combined. In addition, features described with reference to some examples may be combined in other examples.

Based on the descriptions of the foregoing implementation manners, a person skilled in the art may clearly understand that the method in the foregoing embodiment may be implemented by software in addition to a necessary universal hardware platform or by hardware only. In most circumstances, the former is a preferred implementation manner. Based on such understanding, the technical solutions of this disclosure essentially, or the part contributing to the prior art may be implemented in a form of a software product. The computer software product is stored in a storage medium (for example, a ROM/RAM, a magnetic disk, or a compact disc), and includes several instructions for instructing a terminal (which may be a mobile phone, a computer, a server, an air conditioner, a network device, or the like) to perform the method described in the embodiments of this disclosure.

The embodiments of this disclosure are described above with reference to the accompanying drawings, but this disclosure is not limited to the foregoing implementation manners. The foregoing implementation manners are merely schematic instead of restrictive. Under enlightenment of this disclosure, a person of ordinary skills in the art may make many forms without departing from aims and the protection scope of claims of this disclosure, all of which fall within the protection scope of this disclosure.

1. An information transmission method, performed by a terminal and comprising:
obtaining assistance information related to a multicast broadcast service; and
determining a priority of a cell reselection frequency based on the assistance information.

2. The information transmission method according to claim 1, wherein the assistance information comprises at least one of following:
a description of a service feature;
information about a frequency supporting the service; or
information about a cell supporting the service.

3. The information transmission method according to claim 2, wherein the description of the service feature comprises at least one of following:
an identifier of the service;
area information of the service;
a start time of the service;
an end time of the service; or
a frequency point of the service; wherein
the area information of the service comprises at least one of following:
an identifier of an area of the service;
cell information;
a radio access network-based notification area;
a tracking area; or
a registration area; wherein
the cell information comprises at least one of following:
a physical cell identifier;
a cell global identifier;
a cell group identifier; or
a cell type identifier; and/or
there is at least one cell indicated by the cell information.

4. The information transmission method according to claim 2, wherein the frequency comprises at least one of following:
a frequency that the terminal is using currently; or
a neighboring frequency; and/or
the information about the frequency supporting the service comprises at least one of following:
a service identifier of the frequency;
an area identifier of the frequency; or
a service sending mode of the frequency; and/or
the cell comprises:
a serving cell that the terminal is located currently; and
a neighboring cell; and/or
the information about the cell supporting the service comprises at least one of following:
a service identifier of the cell;
an area identifier of the cell; or
a service sending mode of the cell.

5. The information transmission method according to claim 4, wherein the area identifier comprises at least one of following:
an area identifier of the service;
cell information;
a radio access network-based notification area;
a tracking area; or
a registration area; and/or
the service sending mode comprises at least one of following:
a point-to-multipoint (PTM) mode;
a point-to-point (PTP) mode;
a mode of waiting for a trigger;
a broadcast or multicast reception mode; or
a connected-mode reception mode; wherein
the mode of waiting for the trigger comprises one of following:
a network device having not sent service data at a radio access network side, and a core network having sent service data to the network device; and
a network device having not sent service data at a radio access network side, and a core network having not sent service data to the network device either.

6. The information transmission method according to claim 1, wherein the obtaining the assistance information related to the multicast broadcast service comprises:
obtaining the assistance information related to the multicast broadcast service via at least one of following:
a system message;
radio resource control (RRC) dedicated signaling;
an application-layer message; or
core network signaling.

7. The information transmission method according to claim 1, further comprising:
obtaining an indication message; wherein
the indication message is used to indicate whether the assistance information has changed; wherein
the indication message is a short message, a first bit or a second bit in the short message is used to indicate whether the assistance information has changed, wherein the first bit refers to at least one used bit in the short message, and the second bit refers to at least one bit in the short message that has not been used; or
the indication message is downlink control information scrambled with a first radio network temporary identifier (RNTI), and the first RNTI refers to an RNTI different from an defined RNTI; wherein
a terminal to which the first RNTI is applicable comprises at least one of following:
a terminal in support of a multicast broadcast service;
a terminal interested in a multicast broadcast service; or all terminals.

8. The information transmission method according to claim 1, wherein the determining the priority of the cell reselection frequency based on the assistance information comprises at least one of following:
setting priorities of all frequencies providing a multicast broadcast service to a same priority that is a highest priority;
setting, according to a transmission manner in a multicast broadcast service, a priority of a frequency providing the multicast broadcast service; or
setting, according to a priority relationship between a frequency providing a multicast broadcast service and another frequency, a priority of the frequency providing the multicast broadcast service and/or the another priority; wherein
the another frequency refers to a frequency that does not provide a multicast broadcast service.

9. The information transmission method according to claim 8, wherein the setting, according to the transmission manner in the multicast broadcast service, the priority of the frequency providing the multicast broadcast service comprises at least one of following:
setting a priority of a first frequency in support of providing a multicast service to the highest priority;
setting a priority of a second frequency in support of providing a broadcast or multicast reception mode to the highest priority;
setting a priority of a third frequency in support of providing a unicast service to a lowest priority;
setting a priority of a fourth frequency in support of providing a connected-mode reception mode to the lowest priority;
setting a priority of a fifth frequency in support of providing a mode of waiting for a trigger to the lowest priority; or
setting a sequence of priority; wherein
the sequence of priority is a priority sequence obtained after at least one of the first frequency,
the second frequency, the third frequency, the fourth frequency, or the fifth frequency is arranged; and/or
the priority relationship is determined by the terminal; or the priority relationship is determined according to a predefined rule.

10. An information transmission method, performed by a network device and comprising:
sending assistance information related to a multicast broadcast service.

11. The information transmission method according to claim 10, wherein the assistance information comprises at least one of following:
a description of a service feature;
information about a frequency supporting the service; or
information about a cell supporting the service.

12. The information transmission method according to claim 11, wherein the description of the service feature comprises at least one of following:
an identifier of the service;
area information of the service;
a start time of the service;
an end time of the service; or
a frequency point of the service; wherein
the area information of the service comprises at least one of following:
an identifier of an area of the service;
cell information;
a radio access network-based notification area;
a tracking area; or
a registration area; wherein
the cell information comprises at least one of following:
a physical cell identifier;
a cell global identifier;
a cell group identifier; or
a cell type identifier; and/or
there is at least one cell indicated by the cell information.

13. The information transmission method according to claim 11, wherein the frequency comprises at least one of following:
a frequency that the terminal is using currently; or
a neighboring frequency; and/or
the information about the frequency supporting the service comprises at least one of following:
a service identifier of the frequency;
an area identifier of the frequency; or
a service sending mode of the frequency.; and/or
the cell comprises:
a serving cell that the terminal is located currently; and
a neighboring cell; and/or
the information about the cell supporting the service comprises at least one of following:
a service identifier of the cell;
an area identifier of the cell; or
a service sending mode of the cell.

14. The information transmission method according to claim 13, wherein the area identifier comprises at least one of following:
an area identifier of the service;
cell information;
a radio access network-based notification area;
a tracking area; or
a registration area; and/or
the service sending mode comprises at least one of following:
a point-to-multipoint (PTM) mode;
a point-to-point (PTP) mode;
a mode of waiting for a trigger;
a broadcast or multicast reception mode; or
a connected-mode reception mode; wherein
the mode of waiting for the trigger comprises one of following:
a network device having not sent service data at a radio access network side, and a core network having sent service data to the network device; and
a network device having not sent service data at a radio access network side, and a core network having not sent service data to the network device either.

15. The information transmission method according to claim 10, wherein the sending the assistance information related to the multicast broadcast service comprises:
sending the assistance information related to the multicast broadcast service via at least one of following:
a system message;
radio resource control (RRC) dedicated signaling;
an application-layer message; or
core network signaling.

16. The information transmission method according to claim 10, further comprising:
sending an indication message; wherein
the indication message is used to indicate whether the assistance information has changed; wherein
the indication message is a short message, a first bit or a second bit in the short message is used to indicate whether the assistance information has changed, wherein the first bit refers to at least one used bit in the short message, and the second bit refers to at least one bit in the short message that has not been used; or
the indication message is downlink control information scrambled with a first radio network temporary identifier (RNTI), and the first RNTI refers to an RNTI different from an defined RNTI; wherein
a terminal to which the first RNTI is applicable comprises at least one of following:
a terminal in support of a multicast broadcast service;
a terminal interested in a multicast broadcast service; or
all terminals.

17. A terminal, comprising a processor, a memory, and a program or an instruction stored in the memory and executable on the processor, wherein the program or the instruction, when executed by the processor, causes the terminal to perform:
obtaining assistance information related to a multicast broadcast service; and
determining a priority of a cell reselection frequency based on the assistance information.

18. A network device, comprising a processor, a memory, and a program or an instruction stored in the memory and executable on the processor, wherein the program or the instruction, when executed by the processor, implements steps of the information transmission method according to claim 10.

19. A non-transitory readable storage medium, wherein the non-transitory readable storage medium stores a program or an instruction, and the program or the instruction, when executed by a processor of a terminal, implements steps of the information transmission method according to claim 1.

20. A non-transitory readable storage medium, wherein the non-transitory readable storage medium stores a program or an instruction, and the program or the instruction, when executed by a processor of a network device, implements steps of the information transmission method according to claim 10.
